(19) United States
(12) Patent Application Publication
(10) Pub. No.: US 2009/0240557 A1
(43) Pub. Date: Sep. 24, 2009

(54) METHOD, APPARATUS AND COMPUTER PROGRAM PRODUCT FOR VALUING A TECHNOLOGICAL INNOVATION

(75) Inventor: Paul C. Hummel, Manchester, MO (US)

Correspondence Address: ALSTON & BIRD, LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 12/051,196

(22) Filed: Mar. 19, 2008

(51) Int. Cl. G06Q 10/00

(52) U.S. Cl. 705/10

(57) ABSTRACT

A method, apparatus and computer program product for valuing a technological innovation is provided which determines at least one measure of market success of an objective based upon the desirability, availability and affordability of the objective. In this regard, the measure of market success may be the salability and/or the marketability of the objective. A fair value of the objective implemented utilizing existing technology may also be determined as well as a fair value of the objective implemented utilizing the technological innovation. For example, the fair value of the objective implemented utilizing either existing technology or the technological innovation may be determined using parameterized cost estimation. A real options pricing model may then be used to determine the value of the technological innovation based upon the fair value of the objective implemented utilizing existing technology and the fair value of the objective implemented utilizing the technological innovation.

### FIELD OF THE INVENTION

Embodiments of the present invention relate generally to techniques for valuing a technological innovation and, more particularly, to techniques for valuing a technological innovation utilizing a real options pricing model.

### BACKGROUND OF THE INVENTION

Technology, as well as the intellectual property underlying the technology, is becoming more of a commodity. For example, within the defense industry, technology, and its underlying intellectual property, was historically created and used by the same contractor. As a result of reform efforts by the U.S. Department of Defense in conjunction with its acquisition process and the improvements in access and communications provided by wide area networks, such as the Internet, contractors are now participating in the acquisition process who did not or could not participate in the past. As such, it is becoming more common that the contractor that created certain technology and its underlying intellectual property may not necessarily be the same contractor that develops and produces a system incorporating the technology. It is therefore becoming increasingly important to be able to value technology and its underlying intellectual property in order to appropriately account for its transfer from one party to another party or to evaluate the financial wisdom in investing in the development of a technological innovation.

While a variety of techniques have been developed to value financial instruments, those techniques are either inapplicable or have otherwise proven difficult to apply to the valuation of technology. In this regard, technology may be defined as the application of science, especially to industrial or commercial objectives. Within a corporation, much of the work product that is generated during a research and development effort aimed at the creation of new technology is documentation. The documentation generally describes technology concepts, prototype construction, test results, etc. Although the paper and ink are tangible assets, the knowledge reflected by the documents is generally of much greater importance. This knowledge is an intangible asset. Intangible assets may be distinguished from other assets in that intangible assets are without physical substance, are not financial instruments and are not current assets. In this regard, the Financial Accounting Standards Board defines intangible assets as assets, not including financial assets, that lack physical substance. Moreover, to be recognized by the Financial Accounting Standards Board, intangible assets should be contextually identifiable, legally ownable, developmentally traceable, legally protectable, existentially provable, temporarily finite and quantifiably valuable.

Intangibles are considered to be assets either because they represent rights to future benefits or because the expenditures that were made to acquire or develop them will serve to benefit a number of future accounting periods. In this regard, intangible assets are those assets characterized by the rights, privileges and benefits of possession, rather than by physical existence.

A wide variety of assets are intangible. For example, intangible assets include accounts receivable, bank deposits, patents, copy rights, franchises, trademarks, trade names, trade secrets, goodwill, etc. An asset's exchangeability is a useful characteristic to distinguish between different types of intangible assets with some intangible assets being readily exchangeable and others, such as goodwill, being less readily exchangeable. If capable of being sold or otherwise transferred, intangible assets constitute a potential source of funds.

To be recognized from an accounting standpoint, intangible assets acquired in transactions other than business combinations must meet four fundamental recognition criteria. These criteria are that the item meets the definition of an asset, the item has an attribute that is measurable with is sufficient reliability, information regarding the asset is capable in making a difference in user decisions and the information is representational, faithful, verifiable and neutral. While arms length's transactions conducted in an open market provide reliable evidence of the existence and fair value of intangible assets, similarly reliable evidence regarding the existence and fair value of intangible assets that have been developed internally is not generally available. If such information is not available without undue cost and effort, the owner of the intangible assets should utilize its own assumptions. However, intangible assets are particularly challenging to evaluate from a valuation standpoint. As noted above, however, there is an increasing need and desire to value intangible assets, such as various technological innovations.

As also noted above, one category of intangible assets is goodwill. Goodwill may be considered to be a company's image or reputation and is related to the likelihood that its customers will continue to conduct business with the company. From an accounting prospective, goodwill is generally described as all intangible and support assets that contribute to the advantage that an established business has over a comparable, but new business. These advantages consist of its image, customers, reputation, perceptions, etc.

Another category of intangible assets is intellectual property. Generated primarily through research, development and advertising, intellectual property includes patents, copyrights, trademarks, trade secrets, technical documentation, etc. Based on the Financial Accounting Standards Board, assigning value to intellectual property involves determining the future income associated with its ownership. Determination of future income requires estimating the income due to the intellectual property in each of the future years of its life. If the intellectual property is to be used internally, then the savings due to the ownership of the intellectual property can be similarly estimated. Unfortunately, the risk that intellectual property becomes obsolete is relatively high as a result of unexpected competition, unauthorized copying, patent infringement or invalidation, loss of trade secrets, etc. As a result of such risks and the resulting potential for obsolescence of the intellectual property, sales or other income that occurs far in the future may be considered to have little effect upon the current value of the intellectual property.

Although a variety of techniques have been developed for valuing tangible assets as well as financial instruments, it is proven difficult to value technology, particularly technology that is internally developed. One technique for estimating the fair value of an intangible asset, such as that associated with the development of technology, is a present value technique. In such a present value technique, the useful lives and amortization periods of intangible assets should reflect the periods over which those assets would contribute to cash flows as opposed to the period of time that would be required to internally develop those assets. However, the estimates of future cash flows may be difficult to make with any precision and may introduce significant subjectivity, thereby calling into question the credibility of such valuations. Historically, a company would solicit the opinions of subject matter experts and then arrive at a value for the technology. However, such estimates are quite subjective and may lack the repeatability and consistency that is desired for meaningful valuation of an asset.

As such, it would be desirable to provide an improved technique for valuing a technological innovation. In particular, it would be desirable to provide an objective technique for valuing a technological innovation such that the valuation is structured and repeatable, thereby adding to the credibility of the resulting valuation.

### BRIEF SUMMARY OF THE INVENTION

A method, apparatus and computer program product are therefore provided for objectively valuing a technological innovation. By employing an objective evaluation process, the resulting valuation may not only be more accurate, but may be more repeatable and comparable to other valuations. By providing an improved valuation technique, the method, apparatus and computer program product of embodiments of the present invention facilitate informed decisions regarding the development of technology and the transfer of technology.

According to one embodiment, a method for valuing a technological innovation is provided which determines at least one measure of market success of an objective based upon the desirability, availability and affordability of the objective. In this regard, the measure of market success may be the salability and/or the marketability of the objective. The method may also determine a fair value of the objective implemented utilizing existing technology and a fair value of the objective implemented utilizing the technological innovation. For example, the fair value of the objective implemented utilizing either existing technology or the technological innovation may be determined using parameterized cost estimation. The method may also use a real options pricing model to determine the value of the technological innovation based upon the fair value of the objective implemented utilizing existing technology and the fair value of the objective implemented utilizing the technological innovation.

In one embodiment, the real options pricing model may determine the value of the technological innovation not only based upon the fair values, but also based upon a risk-free rate. In another embodiment, the real options pricing model may determine the value of the technological innovation not only based upon the fair values, but also based upon a date at which the technological innovation reaches a predefined technology readiness level. Additionally, the real options pricing model of this embodiment may also determine the value of the technological innovation based upon a measure of lost value in the technological innovation prior to the date. Further, the real options pricing model of one embodiment may determine the value of the technological innovation not only based upon the fair values, but also based upon volatility in the value of the technological innovation.

A corresponding apparatus and computer program product were also provided according to other embodiments of the present invention for valuing a technological innovation. In this regard, the apparatus includes a processor which is configured to perform the functions associated with the valuation of a technological innovation. Similarly, a computer program product includes a computer readable storage medium having computer readable code embodied in the storage medium and including executable portions for performing the functions associated with valuing a technological innovation. As such, the method, apparatus and computer program product of embodiments of the present invention advantageously provide objective techniques for valuing a technological innovation.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flow chart illustrating operations performed in accordance with embodiments of the present invention; and

FIG. 2 is a block diagram of an apparatus capable of valuing a technological innovation in accordance with embodiments of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

In accordance with embodiments of the present invention, techniques are provided for valuing a technological innovation. The techniques can value a wide variety of technological innovations including, for example, communications technology, navigation systems technology, computing technology, software, interfaces and the like. Regardless of the particular technology, the technological innovation generally not only includes the resulting technology, but also the underlying intellectual property.

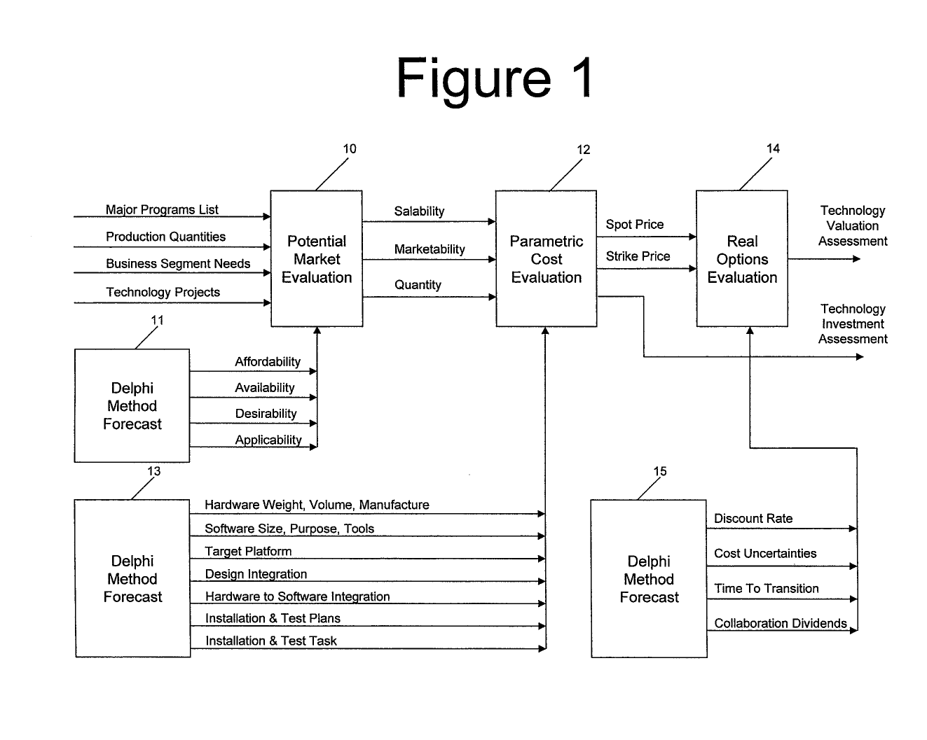

In accordance with embodiments of the present invention, at least one measure of market success of an objective, e.g., a goal, implemented utilizing the technological innovation is determined based upon the desirability, availability, affordability and applicability of the objective, as well as business input which defines the market. In the context of a business which has a number of business segments and which invests in research and development for a variety of different programs, the measure of market success of an objective may also depend upon the programs of interest, e.g., the major programs, the production quantities, the business segment needs and the technology projects of interest. See block 10 of FIG. 1. For example, the salability and/or marketability of the objective may be determined as measures of the market success of the objective. In order to determine the desirability, availability, applicability and affordability of the objective and in turn, to determine a measure of market success of the objective, information is gathered regarding the potential customers' perception of the objective. The information that is gathered may then be quantified and combined statistically to calculate measures of the objective's market success.

In order to consummate a sale, a buyer must perceive the offer as desirable, available, and affordable. In this context, the desirability, availability and affordability of an offer describe the buyers' perception toward the offering's features, risks and price, respectively. The desirability of an offering usually relates to what the offering can do, how well the offering can do it and how much it costs to keep the offering functional. In other words, the desirability of an offering usually relates to its operational function, operational performance and operational costs. Desirability is realized through capabilities and functions that are designed into an offering. In this context, capabilities refer to the various desired performance attributes and measures of the offering, such as speed, range, altitude, accuracy, etc. On the other hand, functions refer to the desired mission capabilities and mission scenarios that the offering must be capable of executing in an operational environment. Operating costs also influence an offering's desirability. Operating costs are based on the offering's reliability, maintainability and supportability. Reliability is the ability of an offering to perform as designed in an operational environment over time without failure. Maintainability is the ability of an offering to be repaired and restored to service when maintenance is conducted by personnel using specified skill levels and prescribed procedures and resources. Supportability is the extent to which an offering lends itself to technical data creation, maintenance procedures creation, anomaly correction, data collection, corrosion protection, logistics reduction, etc.

Availability is a measure of the buyer's perception of the seller's ability and commitment to make the offering available when it is needed. Availability relates to technical and schedule risks that pertain to a producer and the offering's inherent ability to be developed, manufactured, assembled and delivered.

Affordability relates to a ratio of the money the buyer has allocated in his/her budget to acquire the offering and the price the seller has attributed to the offering. Affordability can be defined as the degree to which the life cycle cost of a offering is in consonance with the long-range plans for resources of the buyer as a whole. Finally, applicability relates to whether an offering is relevant or useful in conjunction with a particular product or project.

The affordability, availability, desirability and applicability of an offering may be determined in various manners, such as by means of a Delphi method. See block 11 of FIG. 1. A Delphi method is a systematic interactive forecasting method for obtaining forecasts from a number of people, such as a panel of independent experts. In one embodiment in which analyzes the affordability, availability and desirability, but not the applicability of an offering, qualitative opinions may be gathered from potential buyers as to their perception of the desirability P(D), availability P(A), and affordability P($) of each product. In order for the opinions of the perspective buyers to be meaningful, the prospective buyer should have knowledge of the features, schedule and price of the product as well as the budget of the buyer. The buyer's opinions as to the desirability, availability, and affordability of each of a plurality of product, designated products 1, 2 . . . product n are then collected as shown in Table 1.

TABLE 1
Perceived desirability, availability, & affordability

| | Buyer 1 | | | Buyer 2 | | | | Buyer m | | |
|---|---|---|---|---|---|---|---|---|---|---|
| Products | P(D) | P(A) | P($) | P(D) | P(A) | P($) | . . . | P(D) | P(A) | P($) |
| Product 1 | | | | High | High | High | . . . | Low | Med | Med |
| Product 2 | High | Med | Med | High | High | High | . . . | | | |
| Product 3 | | | | High | High | High | . . . | Low | Med | Med |
| . | . | . | . | . | . | . | . | . | . | . |
| . | . | . | . | . | . | . | . | . | . | . |
| . | . | . | . | . | . | . | . | . | . | . |
| Product n | Low | High | High | High | Med | Med | . . . | Med | Med | High |

As will be noted from Table 1, the qualitative value may simply be indicated as high, medium, low or not applicable (as evidenced by a blank space or lack of an entry). However, other qualitative values or expressions can be utilized, if so desired.

In one embodiment, after the qualitative values for desirability, availability, and affordability have been collected, the qualitative values may be converted to quantitative values. As such, a conversion from each qualitative value to a respective quantitative value should be defined for each of the desirability, availability and affordability parameters. One example of conversion function is reflected below in Table 2.

TABLE 2
Probability Conversion

| | Quantitative | | |
|---|---|---|---|
| Qualitative | P(D) | P(A) | P($) |
| Low | 0.3 | 0.3 | 0.3 |
| Med | 0.6 | 0.6 | 0.6 |
| High | 0.9 | 0.9 | 0.9 |

For example, a low perception of desirability would be replaced with 0.3, while a high perception of affordability would be replaced with 0.9. While the same conversion factors are utilized in conjunction with each of the desirability, availability and affordability parameters in the illustrated embodiment, different conversion factors may be employed for desirability, availability and/or affordability in another embodiment. Based on the conversion factors provided by Table 2, the perceived desirability, availability and affordability parameters set forth in Table 1 can be expressed with quantitative values as set forth below in Table 3.

TABLE 3

| Prod- | Buyer 1 | | | Buyer 2 | | | Buyer m | | |
|---|---|---|---|---|---|---|---|---|---|
| ucts | P(D) | P(A) | P($) | P(D) | P(A) | P($) | P(D) | P(A) | P($) |
| Product | | | | 0.9 | 0.9 | 0.9 | 0.3 | 0.6 | 0.6 |
| 1 | | | | | | | | | |
| Product | 0.9 | 0.6 | 0.6 | 0.9 | 0.9 | 0.9 | | | |
| 2 | | | | | | | | | |
| Product | | | | 0.9 | 0.9 | 0.9 | 0.3 | 0.6 | 0.6 |
| 3 | | | | | | | | | |
| . | | | | | | | | | |
| . | | | | | | | | | |
| . | | | | | | | | | |
| Product | 0.3 | 0.9 | 0.9 | 0.9 | 0.6 | 0.6 | 0.6 | 0.6 | 0.9 |
| n | | | | | | | | | |

As noted above, at least one measure of market success of the objective is its salability as determined based upon the desirability, availability and affordability of the objective. In particular, salability P(S) is the conditional probability that the i^{th} buyer perceives the j^{th} product is desirable, available, and affordability. As such, salability can be expressed mathematically as:

P(S)_{i,j}=P(D)_{i,j}·P(A)_{i,j}·P($)_{i,j}

Continuing with the example provided above and reflected in Tables 1-3, the salability for each product-buyer combination may be determined as reflected below in Table 4. As shown, in instances in which a buyer does not express a desirability, availability or affordability for a product, the resulting salability of the product-buyer combination is zero.

TABLE 4
Salability - P(S)

| Products | Buyer 1 | Buyer 2 | . . . | Buyer m |
|---|---|---|---|---|
| Product 1 | 0 | 0.729 | . . . | 0.108 |
| Product 2 | 0.324 | 0.729 | . . . | 0 |
| Product 3 | 0 | 0.729 | . . . | 0.108 |
| . | . | . | . | . |
| . | . | . | . | . |
| . | . | . | . | . |
| Product n | 0.243 | 0.324 | . . . | 0.486 |

As noted above, another measure of market success which may be determined in accordance with embodiments of the present invention is the marketability of a product, P(M). The marketability of a product is a probability that sales will exceed a break-even threshold K. In this regard, an attempt to sell a product to a buyer has two possible outcomes, i.e., either the sale is consummated or not. If the sale occurs, the outcome is considered a success S and if the sale does not occur, the outcome is considered a failure F. In one embodiment, an assumption is made that repeated attempts to sell a particular product to a particular buyer are independent trials with constant probabilities p and q in which p is the probability of success and q is the probability of failure. Such attempts are called Bernoulli trials. As such, p=P(S) and q=1−P(S). In order to determine the marketability of a single product, a sample space [S] is generated, one example of which is shown in Table 5.

TABLE 5
Sample space for i^{th} product

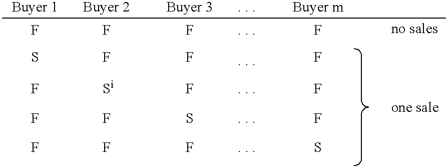

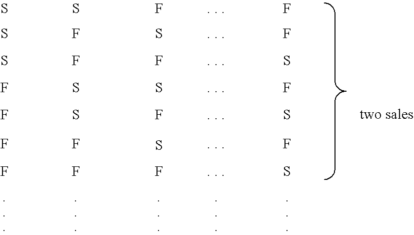

Each column of Table 5 is a dimension, while each row is a point. All of the rows taken together represent an exhaustive set of outcomes called the “sample space”. As such, the sample space is all possible combinations of outcomes for a particular product being sold to a set of buyers.

Row 1 of Table 5 reflects the outcomes when no sales occur, i.e., when all sales attempts fail. Row 1 represents the outcomes when a sale (S) to Buyer 1 occurs, but attempts to all of the others buyers fail (F). Row 2 reflects the outcomes when a sale to Buyer 2 is consummated, but all of the other sales efforts fail. Thus, Rows 1 through m reflect outcomes in which a single sale is made. In the same fashion, outcomes in which two, but only two, sales are made are reflected by Rows m+1 through m+1+C(m,2) where C(m,2) as a number of combinations possible by selling to 2 of m buyers at a time. The sample space is completed in this manner until the last row contains the outcomes of the product being sold to all m buyers. As such, the sample space for each product will have m columns and m rows.

The probability space for the i^{th} product is then generated by inserting into the matrix the probability that the value of each dimension will occur, i.e., F or S is replaced in the sample space by the corresponding value of p or q, respectively. The probability of a point in the sample space is thus the product of the probabilities of the dimensions associated with the point. The probability of an event is, in turn, determined by adding the probabilities associated with all of the sample points favorable to the event. For example, assume there are five potential buyers. To determine the probability that more than one buyer, i.e., two or more buyers, will buy a product, the probabilities of the points in which two, three, four, and five buyers buy the product are added. As will be apparent, the value of P(M) will always be less than or equal to unity. Further details regarding the determination of the salability and marketability of an objective are provided by U.S. Patent Application Publication No. US 2005/0149380 filed Jan. 7, 2004 to Parl C. Hummel, the contents of which are incorporated herein by reference in their entirety.

In order to value a technological innovation, the fair value of the objective is also determined as shown in block 12 of FIG. 1. Additionally, the fair value of the objective implemented utilizing the technological innovation is also determined. In this regard, fair value is the price received for an asset that is sold or the price that is paid for a transferred liability in a hypothetical orderly transaction on the open market at the date of the sale or transfer, i.e. the measurement date. A fair value measurement assumes that the asset or liability is exchanged in an orderly transaction between market participants who sell the asset or transfer the liability of the measurement date. An orderly transaction is a transaction that assumes exposure to the market for a period prior to the measurement date to allow for marketing activities that are usual and customary for transactions involving such assets or liabilities. An orderly transaction is not, however, a forced transaction, such as a force liquidation of distress sale. Moreover, a fair value measurement assumes that the transaction to sell the asset or transfer the liability occurs in the principal market for the asset or liability or, in the absence of a principal market, the most advantageous market for the asset or liability.

Various pricing tools have been developed for determining the fair value of an asset in a manner that is consistent with generally accepted accounting practices and the Financial Accounting Standards Board. In this regard, these pricing techniques are generally consistent with the market approach, the income approach and the cost approach for measuring fair value. The market approach utilizes prices and other information from market transactions involving identical or comparable assets or liabilities. The income approach uses valuation techniques to convert future amount, such as cash flows or earnings, to a single present amount. The cost approach is based on the amount that currently would be required to replace the service capacity of an asset, typically referenced as the current replacement cost.

In one embodiment, the fair value of an objective implemented utilizing existing technology and of that same objective implemented utilizing the technological innovation is determined using parameterized cost estimation. A variety of parameterized cost estimation tools are commercially available including SEER™ cost estimation tools available from Galorath Incorporated, PRICE™ parametric cost estimation tool available from PRICE Systems, and the P-BEAT™ cost estimation tool available from NASA. As shown in FIG. 1, a parametric cost estimation tool 12 receives technical, financial and schedule information along with the salability and marketability of the objective and then predicts the fair value utilizing predefined cost estimating relationships. In this regard, parametric modeling is based on cost estimating relationships that use characteristics that can be quantified, such as weight, volume and manufacturing methods. These characteristics are then used to estimate variables that are generally more difficult to quantify, such as cost and production schedules. The cost estimating relationships employed by the foregoing cost estimating tools may be determined using historical data from commercial and/or governmental contracts. In regard to the development of computer technology, for example, these cost estimation tools can predict the fair value of the hardware and the software as well as the fair value of the engineering services required to integrate the hardware and software with other hardware and software.

In the example depicted in FIG. 1 in the context of the development of computer-related technology, various hardware and software parameters may be provided to a parametric cost estimation tool 12 to determine the fair value of the objective. Typically, two sets of parameters would be provided to the parametric cost estimation tool. In this regard, a first set of parameters which is premised upon the utilization of existing technology are provided to the parametric cost estimation in order to determine the fair value of the objective implemented utilizing existing technology. Additionally, a second set of parameters premised upon the utilization of the technological innovation is also provided to the parametric cost estimation tool for determining the fair value of the objective implemented utilizing the technological innovation. While a variety of parameters may be provided to the parametric cost estimation tool depending upon the type of technology, one example of the parameters provided to the parametric cost estimation tool in conjunction with the valuation of computer-based technology includes both hardware parameters and software parameters. In this regard, the hardware parameters can include one or more of weight, volume, manufacture (e.g., the method of manufacture and/or the manufacturing complexity), product platform, design integration complexity, hardware to software integration complexity, integration and test plans complexity, integration and test task complexity and software parameters such as one or more of software size (e.g., source lines of code), purpose of the software, tools required for software development software application complexity, integration task complexity and development environment productivity. The definition of such parameters as well as the cost estimating relationships which analyze these parameters are well known to those skilled in the art, including those familiar with the commercially available cost estimation tools described above. Moreover, these parameters can be provided in various manners including as a forcast provided by a Delphi method. See block 13 of FIG. 1.

Additionally, the quantity of the objective, e.g., product, may also be provided to the cost estimation tool 12. While the quantity may simply be predefined, the quantity may be determined in other embodiments based upon the projected needs of various programs, business segments and projects as well as the applicability of the objective to the various needs. In this regard, there may be a projected need of 100 units. However, the objective which is the subject of the current valuation may only be applicable in conjunction with 75% of the units. In this instance, a quantity of 75 can be provided to the cost estimation tool.

The fair value of the objective implemented utilizing existing technology is analogous to the spot price of a stock, i.e., the price for which a stock currently sells. Similarly, the fair value of the objective implemented utilizing the technological innovation is analogous to the strike price of a stock, i.e., the price identified in an option contract for which the stock will subsequently be sold on the exercise date.

As shown in FIG. 1, the parametric cost evaluation tool 12 can also provide a technology investment assessment. The technology investment assessment may define the money which will or has been expended to develop a mature technology that can be deployed to satisfy the objective.

According to one embodiment of the present invention, a real options pricing model 16 is then utilized to provide a technology valuation assessment, that is, to determine the value of the technological innovation. As shown in FIG. 1, the real options pricing model receives a plurality of inputs and, based upon those inputs, determines a value of the technological innovation. The inputs will depend upon the type of real options pricing model than is utilized. In this regard, while a Black-Scholes-Merton financial options pricing model will be described in more detail below, other types of real options pricing models can be utilized, such as a Cox-Ross-Rubenstein binomial options pricing method or the real options pricing methodology described by U.S. Pat. No. 6,862,579 entitled “Systems, Methods and Computer Program Products for Performing a Generalized Contingent Claim Valuation,” U.S. patent application Ser. No. 10/309,659 entitled “Systems, Methods and Computer Program Products for Performing a Contingent Claim Valuation,” U.S. patent application Ser. No. 11/613,959 entitled “System, Method and Computer Program Product for Performing a Contingent Claim Valuation of a Combination Option,” U.S. patent application Ser. No. 11/613,967 entitled “System, Method and Computer Program Product for Determining a Minimum Asset Value for Exercising a Contingent Claim of an Option,” U.S. patent application Ser. No. 11/613,929 entitled “System, Method and Computer Program Product for Performing a Contingent Claim Valuation of a Multi-Stage Option,” U.S. patent application Ser. No. 11/613,954 entitled “System, Method and Computer Program Product for Performing a Contingent Claim Valuation of an Early-Launch Option,” and U.S. patent application Ser. Nos. 11/613,993, 11/614,009, 11/613,979 and 11/613,941 which are all entitled “System, Method and Computer Program Product for Determining a Minimum Asset Value for Exercising a Contingent Claim of an Option,” the contents of all of which are hereby incorporated by reference in their entirety.

In terms of a Black-Scholes-Merton real options pricing model, a call option can be defined as follows:

C(S,T)=S·exp(−q·T)·Φ(−d₊)−K·exp(−r·T)·Φ(d₋)

wherein

Φ=normal cumulative distribution function

S=spot price (i.e., current price)

K=strike price (i.e., exercise price)

T=time to expiry

r=risk free rate (constant)

q=dividend yield (constant)

σ=volatility (constant)

In this regard, the call option is an option to buy or invest in a particular technological innovation at a particular time T in the future. Similarly, a put option can be defined as follows:

P(S,T)=K·exp(−r·T)·Φ(−d₋)−S·exp(−q·T)·Φ(−d₊)

In this regard, a put option is an option to sell a particular technological innovation at a particular time T in the future for a particular price, that is, the strike price or exercise price K.

As the foregoing equations illustrate, the Black-Scholes-Merton real options pricing model depends upon six variables which influence the value of the respective option. These six variables are the spot price or the current price S, the strike price or the exercise price K, the dividend yield q, the risk free rate r, the volatility σ and the time to expiry T. Of these, the spot price and the strike price have been described above and are generally determined utilizing parameterized cost estimation 10. It is noted, however, that in instances in which an objective has not been implemented utilizing existing technology, the spot price is typically set equal to the strike price which is defined as the fair value of the objective implemented utilizing the technological innovation, as described above.

In the financial context involving an option for a stock, dividends represent the value that flows out of the stock price between the purchase of the option and its exercise. In regards to the valuation of a technological innovation, the dividend yield q therefore is the value of the technological innovation that is lost prior to the implementation of the objective utilizing the technological innovation, termed collaboration dividends in FIG. 1. For example, some of the value of a technological innovation may be lost as a result of the discovery of new technology or the release, disclosure or other discovery of information regarding the technological innovation to competitors or to the public as a whole. Typically, the value of the dividend is defined based on historical information. For example, a company could determine over time the average value that is lost prior to the implementation of an objective utilizing similar types of technological innovations. This average value could then be utilized as the dividend in the foregoing equations.

The risk-free rate is the interest rate paid on a financial instrument for which there is no chance of default. While there are no completely risk free investments in reality, short-dated government bonds are a good approximation of a risk-free rate for practical purposes. In this regard, short-dated government bonds are considered to be risk-free because the likelihood of a government default is extremely low, while the short maturity of the bond protects the investor from interest-rate risk that is present in all fixed rate bonds. One example of a suitable short-dated government bond is a U.S. Treasury Bill (T-Bill) that matures in one year or less. In the context of FIG. 1, the discount rate is employed as the risk-free rate in regards to the Black-Scholes-Merton real options pricing model.

As to the expiry date, in the context of a financial option contract, the expiration is the date on which the contract expires, at which time the option holder must either elect to exercise the option or allow the option to expire without taking any action. While the expiry date may be defined in various manners in conjunction with the utilization of a real options pricing model to value a technological innovation, one definition of the expiry date is the date on which the technology reaches a predefined technology readiness level. As such, the expiry date is termed the time to transition in FIG. 1. While various definitions of technology readiness levels can be employed, one common set of technology readiness levels is the NASA definition of technology readiness levels which is set forth below.

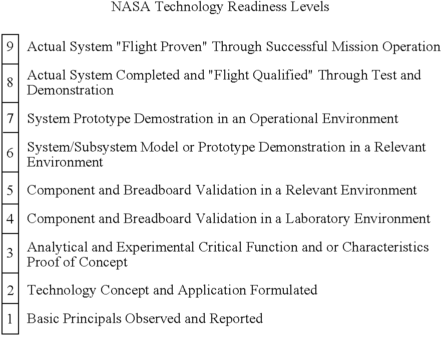

While various readiness levels can be identified to define the expiry date, one embodiment of the present invention identifies the expiry date as the date at which the technology reaches NASA technology readiness level 6 in which a system, subsystem or other prototype is successfully demonstrated in a relevant environment. Further details regarding technology readiness levels in the context of a real options pricing model are provided by U.S. patent application Ser. No. 10/453,395 entitled “Systems, Methods and Computer Program Products for Modeling a Monetary Measure for a Good Based Upon Technology Maturity Levels,” the contents of which are incorporated herein in their entirety.

The final variable of the real options pricing model described above is volatility. In terms of the valuation of a financial instrument, volatility refers to the standard deviation of the change in value of a financial instrument within a specific time horizon. As such, volatility may be used to quantify the risk of the instrument over the relevant time period. Volatility is typically expressed in annualized terms. Additionally, volatility for a Gaussian random walk or Wiener process, such as the price of a financial instrument, increases as time increases. This increase occurs as a result of an increasing probability that the price of the financial instrument will be further away from the initial price as time elapses. However, since some steps of the random walk cancel other steps, the volatility increases, not linearly with time, but with the square root of time. Volatility may be expressed as an absolute number or a fraction of the initial value. In the Black-Scholes-Merton real options pricing model, volatility is the standard deviation of the annualized logarithmic rate of return on investment. This definition may be defined as follows:

$$σ = σ ( ln ( \frac{{V}_{1 i}}{{V}_{0 i}} ) )$$

wherein V₀ᵢ is the value of the investment at the beginning of a one year period for the i^{th} investor, while the V₁ᵢ is the value of the investment at the end of the one year period for the i^{th} investor. In the context of the valuation of a technological innovation, the volatility is typically based upon historical information and is termed cost uncertainties in FIG. 1. For example, the volatility can be defined as the average volatility associated with the price of similar technological innovations that have been developed and productized in the past by the same company.

The parameters provided to the Black-Scholes-Merton real options pricing model, such as represented by the discount rate, cost uncertainties, time to transition and collaboration dividends, can be provided in various manners as described above. For example, these parameters can be forecast by a Delphi method. See block 15 of FIG. 1.

The result of the real options pricing model is a determination of the value of the technological innovation. By determining the value of a technological innovation, embodiments of the present invention facilitate the accounting for the technological innovation and inform decisions relating to the technological innovation including decisions relating to further investment in the technological innovation, sale or purchase of the technological innovation or the like. The process of valuing a technological innovation can therefore be performed more objectively and repeatedly with corresponding less reliance upon subjective judgments of value which are difficult to quantifiably support and may prove challenging to reproduce.

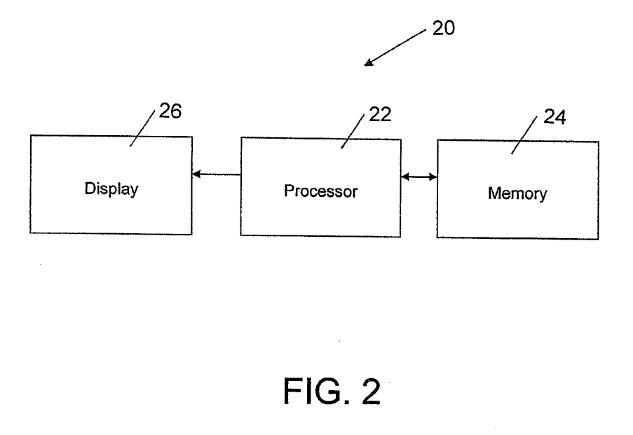

As shown in FIG. 2, the apparatus 20 of embodiments of the present invention is typically embodied by a processing element 22 and an associated memory device 24, both of which are commonly comprised by a computer or the like. In this regard, the method of embodiments of the present invention as set forth generally in FIG. 1 can be performed by the processing element executing a computer program instructions stored by the memory device. The memory device may also store the data in some embodiments. The computer can include a display 26 for presenting the image and any other information relative to performing embodiments of the method of the present invention.

The apparatus 20 may operate under control of a computer program product according to another aspect of the present invention. The computer program product for performing the methods of embodiments of the present invention includes a computer-readable storage medium, such as the non-volatile storage medium, e.g., memory device 24, and computer-readable program code portions, such as a series of computer instructions, embodied in the computer-readable storage medium.

In this regard, FIG. 1 depicts the operations performed by the methods, systems and program products according to exemplary embodiments of the present invention. It will be understood that each operation can be implemented by computer program instructions. These computer program instructions may be loaded onto a computer or other programmable apparatus, e.g., processing element 22, to produce a machine, such that the instructions which execute on the computer or other programmable apparatus create means for implementing the operations illustrated in FIG. 1. These computer program instructions may also be stored in a computer-readable memory that can direct a computer or other programmable apparatus to function in a particular manner, such that the instructions stored in the computer-readable memory produce an article of manufacture including instruction means which implement the operations illustrated in FIG. 1. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the operations illustrated in FIG. 1. It will also be understood that the operations illustrated in FIG. 1 can be implemented by special purpose hardware-based computer systems which perform the operations, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for valuing a technological innovation comprising:
determining at least one measure of market success of an objective based upon desirability, availability and affordability of the objective;
determining a fair value of the objective implemented utilizing existing technology and the fair value of the objective implemented utilizing the technological innovation based upon the at least one measure of market success of the objective; and
using a real options pricing model to determine a value of the technological innovation based upon the fair value of the objective implemented utilizing existing technology and the fair value of the objective implemented utilizing the technological innovation.

2. A method according to claim 1 wherein using the real options pricing model comprises determining the value of the technological innovation further based upon a risk-free rate.

3. A method according to claim 1 wherein using the real options pricing model comprises determining the value of the technological innovation further based upon a date at which the technology innovation reaches a predefined technology readiness level.

4. A method according to claim 3 wherein using the real options pricing model comprises determining the value of the technological innovation further based upon a measure of lost value in the technological innovation prior to the date.

5. A method according to claim 1 wherein using the real options pricing model comprises determining the value of the technological innovation further based upon volatility in the value of the technological innovation.

6. A method according to claim 1 wherein determining the fair value comprises using parameterized cost estimation to determine the fair value of the objective implemented utilizing existing technology and the fair value of the objective implemented utilizing the technological innovation.

7. A method according to claim 1 wherein determining at least one measure of market success comprises determining salability and marketability of the objective based upon the desirability, availability and affordability of the objective.

8. An apparatus for valuing a technological innovation comprising:
a processor configured to determine at least one measure of market success of an objective based upon desirability, availability and affordability of the objective, wherein the processor is also configured to determine a fair value of the objective implemented utilizing existing technology and a fair value of the objective implemented utilizing the technological innovation based upon the at least one measure of market success, and wherein the processor is further configured to use a real options pricing model to determine a value of the technological innovation based upon the fair value of the objective implemented utilizing existing technology and the fair value of the objective implemented utilizing the technological innovation.

9. An apparatus according to claim 8 wherein the processor is further configured to at least partially rely upon a risk-free rate in order to determine the value of the technological innovation using the real options pricing model.

10. An apparatus according to claim 8 wherein the processor is further configured to at least partially rely upon a date at which the technology innovation reaches a predefined technology readiness level in order to determine the value of the technological innovation using the real options pricing model.

11. An apparatus according to claim 10 wherein the processor is further configured to at least partially rely upon a measure of lost value in the technological innovation prior to the date in order to determine the value of the technological innovation using the real options pricing model.

12. An apparatus according to claim 8 wherein the processor is further configured to at least partially rely upon a volatility in the value of the technological innovation in order to determine the value of the technological innovation using the real options pricing model.

13. An apparatus according to claim 8 wherein the processor is configured to use parameterized cost estimation to determine the fair value of the objective implemented utilizing existing technology and the fair value of the objective implemented utilizing the technological innovation.

14. An apparatus according to claim 8 wherein the processor is further configured to determine salability and marketability as respective measures of success of the objective based upon the desirability, availability and affordability of the objective.

15. A computer program product for valuing a technological innovation, wherein the computer program product comprises a computer readable storage medium having computer readable program code embodied in said medium, said computer-readable program code comprising:
a first executable portion configured to determine at least one measure of market success of an objective based upon desirability, availability and affordability of the objective;
a second executable portion configured to determine a fair value of the objective implemented utilizing existing technology and a fair value of the objective implemented utilizing the technological innovation based upon at least one measure of market success of the objective; and
a third executable portion configured to use a real options pricing model to determine a value of the technological innovation based upon the fair value of the objective implemented utilizing existing technology and the fair value of the objective implemented utilizing the technological innovation.

16. A computer program product according to claim 15 wherein the third executable portion is further configured to at least partially rely upon a risk-free rate in order to determine the value of the technological innovation using the real options pricing model.

17. A computer program product according to claim 15 wherein the third executable portion is further configured to at least partially rely upon a date at which the technology innovation reaches a predefined technology readiness level in order to determine the value of the technological innovation using the real options pricing model.

18. A computer program product according to claim 17 wherein the third executable portion is further configured to at least partially rely upon a measure of lost value in the technological innovation prior to the date in order to determine the value of the technological innovation using the real options pricing model.

19. A computer program product according to claim 15 wherein the third executable portion is further configured to at least partially rely upon a volatility in the value of the technological innovation in order to determine the value of the technological innovation using the real options pricing model.

20. A computer program product according to claim 15 wherein the second executable portion is configured to use parameterized cost estimation to determine the fair value of the objective implemented utilizing existing technology and the fair value of the objective implemented utilizing the technological innovation.

21. A computer program product according to claim 15 wherein the first executable portion is further configured to determine salability and marketability as respective measures of success of the objective based upon the desirability, availability and affordability of the objective.
